(19) United States
(12) Patent Application Publication
(10) Pub. No.: US 2024/0162485 A1
(43) Pub. Date: May 16, 2024

(54) SOLID ELECTROLYTE MATERIAL AND BATTERY USING SAME

(71) Applicant: Panasonic Intellectual Property Management Co., Ltd., Osaka (JP)

(72) Inventors: TOMOYASU YOKOYAMA, Osaka (JP); KAZUHIDE ICHIKAWA, Kyoto (JP)

(21) Appl. No.: 18/418,292

(22) Filed: Jan. 21, 2024

Related U.S. Application Data
(63) Continuation of application No. PCT/JP2022/020310, filed on May 16, 2022.

(30) Foreign Application Priority Data
Aug. 2, 2021 (JP) 2021-126926

(51) Int. Cl. H01M 10/0562; H01M 10/0525

(52) U.S. Cl. CPC H01M 10/0562; H01M 10/0525; H01M 2300/008

(57) ABSTRACT

A solid electrolyte material comprises a cation A that is an ion conductive species, a cation B that is not an ion conductive species, an anion X, and an anion Z. The cation A is at least one element selected from the group consisting of alkali and alkaline earth metal elements. The cation B is at least one element selected from the group consisting of alkali and alkaline earth metal elements other than the cation A, transition metal elements, and the Groups 13 to 16 elements. The anions X and Z are each independently at least one element selected from the group consisting of the Groups 14 to 17 elements. The anions X and Z constitute an anion framework having a MgCu₂-type structure. The molar ratio of the anion X to the anion Z is greater than or equal to 1 and less than or equal to 4.

### BACKGROUND

### 1. Technical Field

The present disclosure relates to a solid electrolyte material and a battery using it.

### 2. Description of the Related Art

Zhu, Zhuoying, Iek-Heng Chu, and Shyue Ping Ong. “Li3Y (PS4)2 and Li5PS4Cl2: new lithium superionic conductors predicted from silver thiophosphates using efficiently tiered ab initio molecular dynamics simulations.” Chemistry of Materials 29.6 (2017): 2474-2484 (Non Patent Literature) discloses a solid electrolyte Li₅PS₄Cl₂ having an anion framework of a NaHg₂-type structure.

### SUMMARY

One non-limiting and exemplary embodiment provides a new solid electrolyte material that is suitable for ion conduction.

In one general aspect, the techniques disclosed here feature a solid electrolyte material comprising a cation A that is an ion conductive species, a cation B that is not an ion conductive species, an anion X, and an anion Z, wherein the cation A is at least one element selected from the group consisting of alkali metal elements and alkaline earth metal elements, the cation B is at least one element selected from the group consisting of alkali metal elements and alkaline earth metal elements other than the cation A, transition metal elements, the Group 13 elements, the Group 14 elements, the Group 15 elements, and the Group 16 elements, the anion X and the anion Z are each independently at least one element selected from the group consisting of the Group 14 elements, the Group 15 elements, the Group 16 elements, and the Group 17 elements, the anion X and the anion Z constitute an anion framework having a MgCu₂-type structure, and the molar ratio of the anion X to the anion Z is greater than or equal to 1 and less than or equal to 4.

The present disclosure provides a new solid electrolyte material that is suitable for ion conduction.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 shows a cross-sectional view of a battery 1000 according to a second embodiment;

FIG. 2 shows a schematic view of a compression molding dies 300 that is used for evaluating the ion conductivity of a solid electrolyte material;

FIG. 3 is a graph showing a cole-cole plot obtained by impedance measurement of a solid electrolyte material of Example 1;

FIG. 4 is a graph showing the initial charge and discharge characteristics of a battery of Example 1; and

FIG. 5 is a graph showing an X-ray diffraction pattern of a solid electrolyte material of Example 1.

### DETAILED DESCRIPTIONS

Embodiments of the present disclosure will now be described with difference to the drawings. The present disclosure is not limited to the following embodiments.

### First Embodiment

The solid electrolyte material according to a first embodiment comprises a cation A that is an ion conductive species, a cation B that is not an ion conductive species, an anion X, and an anion Z. The cation A is at least one element selected from the group consisting of alkali metal elements and alkaline earth metal elements. The cation B is at least one element selected from the group consisting of alkali metal elements and alkaline earth metal elements other than the cation A, transition metal elements, the Group 13 elements, the Group 14 elements, the Group 15 elements, and the Group 16 elements. The anion X and the anion Z are each independently at least one element selected from the group consisting of the Group 14 elements, the Group 15 elements, the Group 16 elements, and the Group 17 elements. The anion X and the anion Z constitute an anion framework having a MgCu₂-type structure. The molar ratio of the anion X to the anion Z is greater than or equal to 1 and less than or equal to 4.

The solid electrolyte material according to the first embodiment is a solid electrolyte material having a structure that is suitable for ion conduction. The solid electrolyte material according to the first embodiment can have, for example, a high lithium ion conductivity. Accordingly, the solid electrolyte material according to the first embodiment can be used for obtaining a battery having excellent charge and discharge characteristics. An example of the battery is an all-solid-state battery. The all-solid-state battery may be a primary battery or may be a secondary battery.

Here, an example of the high lithium ion conductivity is, for example, greater than or equal to 7×10⁻⁶ S/cm at around room temperature (e.g., 25° C.). The solid electrolyte material according to the first embodiment can have, for example, an ion conductivity of greater than or equal to 7×10⁻⁶ S/cm.

The anion framework is a crystal structure constituted of anions. For details, the anion framework is, for example, a crystal structure consisting of negatively charged ions (i.e., anions) obtained by removing positively charged ions (i.e., cations) from an ionic crystal. For example, the anion framework of Li₃YCl₆ is a crystal structure constituted of Cl⁻ anions excluding Li⁺ and Y³⁺ cations.

In the solid electrolyte material, the ion conductive species diffuses while interacting with the anion framework. Accordingly, the geometry of the anion framework strongly influences the ion conduction.

The MgCu₂-type structure is called Laves phase and is known as one of Frank-Kasper phases or Tetragonal (Topologically) Closed-packed (TCP) phases. In this structure, atoms are located at vertices of a space-filling tetrahedron that is almost a regular tetrahedron. Since the anion framework has a MgCu₂-type structure, the activation energy of ion diffusion can be reduced, and a high ion conduction is expressed. When an ion at one site diffuses to a neighboring site, if there is a difference in potential (site energy) felt by the ion, the ion cannot diffuse continuously. For example, when the anion framework has a structure in which a Cl-tetrahedron and a Cl-octahedron share a surface, as in LiCl having an fcc structure, since the coordination environments of the Li ion in the tetrahedron site and the Li ion in the octahedron site are different, a difference occurs in the potentials felt by the Li ions. In LiCl, since the potential of a tetrahedron site is higher than that of an octahedron site, Li ions present in the octahedron site cannot diffuse to the tetrahedron site and have a low ion conductivity. In contrast, when the anion framework has a structure in which S²⁻ tetrahedrons share a surface, as in Ag₈GeS₆ having a MgCu₂-type structure, since adjacent sites are all tetrahedron sites, the potentials felt by Ag ions are the same at both sites. Accordingly, an Ag ion can easily diffuse to a neighboring site, and a high ion conductivity is expressed.

The MgCu₂-type anion framework structure is a structure in which the Mg atom is replaced by an anion Z, the Cu atoms are replaced by an anion X, and a 16-coordination octacosahedron composed of 4 of the anion Z and 12 of the anion X bonded so as to surround the anion Z is arranged in an fcc-type structure. A change in the ratio of the anion X and the anion Z constituting this octacosahedron influences the ion conductivity. For example, it is possible to have a composition in which the ratio of the anion X and the anion Z is 2:1 as described above or to have a composition in which the ratio of the anion X and the anion Z is 5:1 such that all of 16 first proximity atoms around the anion Z are the anion X. Alternatively, it is possible to have a composition in which all atoms are substituted with anion X. Mixing a plurality of elements tends to increase the entropy of mixing and enhance the ion conductivity. Accordingly, if the structures are the same, a higher ion conductivity can be achieved by mixing a plurality of anions. In particular, the entropy of mixing when the ratio of the anion X and the anion Z (anion X:anion Z) is 2:1 is larger than that when the ratio is 5:1, and the entropy of mixing is the highest when the ratio is 1:1. However, since the MgCu₂-type structure becomes structurally unstable at a ratio of the anion X and the anion Z (anion X:anion Z) of 1:1, when the ratio of the anion X and the anion Z is 2:1, both a high ion conductivity and a high stability can be achieved.

Here, in order to evaluate whether the elements constituting a solid electrolyte material are anions or cations, measurement by X-ray photoelectron spectroscopy (XPS) can be used. When the binding energy obtained by XPS measurement is smaller than that of the single metal, the element is negatively charged and can be judged to be an anion. In contrast, when the binding energy is larger than that of the single metal, the element is positively charged and can be judged to be a cation. For example, the binding energy of the 2p orbit of P of InP in which P is an anion is 128.9 eV, which is smaller than the binding energy, 130.1 eV, of the 2p orbit of simple P. In contrast, the binding energy of the 2p orbit of P of P₄O₁₀ in which P is a cation is 135.5 eV, which is larger than the binding energy of simple P.

The solid electrolyte material according to the first embodiment may contain an element that is unavoidably mixed. Examples of the element are hydrogen, nitrogen, and oxygen. These elements may be present in the raw material powders of the solid electrolyte material or in the atmosphere for manufacturing or storing the solid electrolyte material. The amount of the element mixed unavoidably in the solid electrolyte material according to the first embodiment is, for example, less than or equal to 1 mol %.

In order to enhance the ion conductivity of the solid electrolyte material, the cation A that is an ion conductive species may include lithium. The cation A that is an ion conductive species may be lithium.

In order to enhance the ion conductivity of the solid electrolyte material, the molar ratio of the anion X to the anion Z may be greater than or equal to 1 and less than or equal to 2.5 or may be 2.

The solid electrolyte material according to the first embodiment may be a material represented by the following formula (1):

Li_{4x+2z-b}BX₄Z₂ (1)

here, B represents a cation B, X represents an anion X, Z represents an anion Z, x represents the absolute value of the valence of the anion X, z represents the absolute value of the valence of the anion Z, and b represents the absolute value of the valence of the cation B.

The solid electrolyte material represented by the formula (1) has a high ion conductivity.

In order to enhance the ion conductivity of the solid electrolyte material, in the formula (1), B may be at least one selected from the group consisting of Zn, P, Si, Sn, and Ge.

In order to enhance the ion conductivity of the solid electrolyte material, in the formula (1), B may be Zn. In this case, b is 2.

In order to enhance the ion conductivity of the solid electrolyte material, in the formula (1), X may be at least one element selected from the Group 15 elements, and Z may at least one element selected from the Group 16 elements. In this case, x is 3, and z is 2.

The shape of the solid electrolyte material according to the first embodiment is not limited. Examples of the shape are needle, spherical, and oval spherical shapes. The solid electrolyte material according to the first embodiment may be a particle. The solid electrolyte material according to the first embodiment may have a pallet or planar shape.

For example, when the shape of the solid electrolyte material according to the first embodiment is particulate (e.g., spherical), the solid electrolyte material according to the first embodiment may have a median diameter of greater than or equal to 0.1 μm and less than or equal to 100 μm or may have a median diameter of greater than or equal to 0.5 μm and less than or equal to 10 μm. Consequently, the solid electrolyte material according to the first embodiment and other materials can be well dispersed. The median diameter means the particle diameter at which the accumulated volume is 50% in a volume-based particle size distribution. The volume-based particle size distribution is measured with, for example, a laser diffraction measurement apparatus or an image analyzer.

### Method for Manufacturing Solid Electrolyte Material According to the First Embodiment

The solid electrolyte material according to the first embodiment is manufactured by, for example, the following method.

As an example, when the target composition is Li₁₄ZnN₄Te₂, a Li₃N raw material powder, a Li₂Te raw material powder, and a ZnTe raw material powder are mixed at a molar ratio of Li₃N:Li₂Te:ZnTe of about 4:1:1. The raw material powders may be mixed at a molar ratio adjusted in advance so as to offset a composition change that may occur during the synthesis process.

As the raw materials, a lithium metal, a zinc metal, or a tellurium metal may be used.

Raw material powders in a mixture form are mechanochemically reacted with each other in a mixing apparatus such as a planetary ball mill to obtain a reaction product. That is, raw material powders are reacted with each other by a mechanochemical milling method. The reaction product may be heat-treated in vacuum or in an inert atmosphere. Alternatively, a mixture of the raw material powders may be heat-treated in vacuum or in an inert atmosphere to obtain a reaction product.

The solid electrolyte material according to the first embodiment is obtained by these methods.

The composition of the solid electrolyte material can be determined by, for example, an XPS method. For example, the compositions of Li, Zn, N, and Te can be determined by an XPS method.

### Second Embodiment

A second embodiment will now be described. Matters described in the first embodiment may be omitted as appropriate.

The battery according to the second embodiment comprises a positive electrode, an electrolyte layer, and a negative electrode. The electrolyte layer is disposed between the positive electrode and the negative electrode. At least one selected from the group consisting of the positive electrode, the electrolyte layer, and the negative electrode comprises the solid electrolyte material according to the first embodiment.

The battery according to the second embodiment comprises the solid electrolyte material according to the first embodiment and therefore has excellent charge and discharge characteristics.

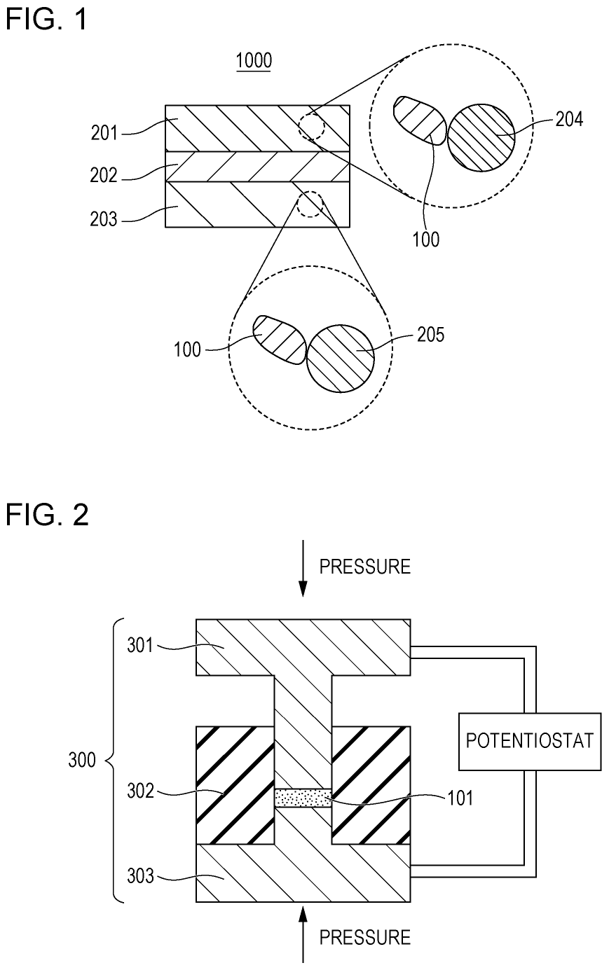

FIG. 1 shows a cross-sectional view of a battery 1000 according to the second embodiment.

The battery 1000 comprises a positive electrode 201, an electrolyte layer 202, and a negative electrode 203. The electrolyte layer 202 is provided between the positive electrode 201 and the negative electrode 203.

The positive electrode 201 contains a positive electrode active material 204 and a solid electrolyte 100.

The negative electrode 203 contains a negative electrode active material 205 and a solid electrolyte 100.

The solid electrolyte 100 includes the solid electrolyte material according to the first embodiment. The solid electrolyte 100 may be a particle including the solid electrolyte material according to the first embodiment as a main component. The particle including the solid electrolyte material according to the first embodiment as a main component means a particle in which the component included in the largest molar ratio is the solid electrolyte material according to the first embodiment. The solid electrolyte particle 100 may be a particle consisting of the solid electrolyte material according to the first embodiment.

The positive electrode 201 contains a material that can occlude and release metal ions such as lithium ions. The material is, for example, the positive electrode active material 204.

Examples of the positive electrode active material are a lithium-containing transition metal oxide, a transition metal fluoride, a polyanionic material, a fluorinated polyanionic material, a transition metal sulfide, a transition metal oxyfluoride, a transition metal oxysulfide, and a transition metal oxynitride. Examples of the lithium-containing transition metal oxide are Li(Ni,Co,Mn)O₂, Li(Ni,Co,Al)O₂, and LiCoO₂.

In the present disclosure, “(A,B,C)” means “at least one selected from the group consisting of A, B, and C”.

The shape of the positive electrode active material 204 is not particularly limited. The positive electrode active material 204 may be a particle. The positive electrode active material 204 may have a median diameter of greater than or equal to 0.1 μm and less than or equal to 100 μm. When the positive electrode active material 204 has a median diameter of greater than or equal to 0.1 μm, the positive electrode active material 204 and the solid electrolyte 100 can be well dispersed in the positive electrode 201. Consequently, the charge and discharge characteristics of the battery 1000 are improved. When the positive electrode active material 204 has a median diameter of less than or equal to 100 μm, the lithium diffusion speed in the positive electrode active material 204 is improved. Consequently, the battery 1000 can operate at a high output.

The positive electrode active material 204 may have a median diameter greater than that of the solid electrolyte 100. Consequently, the positive electrode active material 204 and the solid electrolyte 100 can be well dispersed.

In order to increase the energy density and output of the battery 1000, in the positive electrode 201, the ratio of the volume of the positive electrode active material 204 to the sum of the volume of the positive electrode active material 204 and the volume of the solid electrolyte 100 may be greater than or equal to 0.30 and less than or equal to 0.95.

In order to increase the energy density and output of the battery 1000, the positive electrode 201 may have a thickness of greater than or equal to 10 μm and less than or equal to 500 μm.

The electrolyte layer 202 contains an electrolyte material. The electrolyte material is, for example, a solid electrolyte material. The electrolyte layer 202 may be a solid electrolyte layer. The electrolyte layer 202 may contain the solid electrolyte material according to the first embodiment.

The electrolyte layer 202 may contain greater than or equal to 50 mass % of the solid electrolyte material according to the first embodiment. The electrolyte layer 202 may contain greater than or equal to 70 mass % of the solid electrolyte material according to the first embodiment. The electrolyte layer 202 may contain greater than or equal to 90 mass % of the solid electrolyte material according to the first embodiment. The electrolyte layer 202 may consist of the solid electrolyte material according to the first embodiment only.

Hereinafter, the solid electrolyte material according to the first embodiment is referred to as first solid electrolyte material. A solid electrolyte material that is different from the solid electrolyte material according to the first embodiment is referred to as second solid electrolyte material.

The electrolyte layer 202 may contain not only the first solid electrolyte material but also the second solid electrolyte material. The first solid electrolyte material and the second solid electrolyte material may be uniformly dispersed in the electrolyte layer 202. A layer consisting of the first solid electrolyte material and a layer consisting of the second solid electrolyte material may be stacked along the stacking direction of the battery 1000.

The electrolyte layer 202 may consist of the second solid electrolyte material only.

The electrolyte layer 202 may have a thickness of greater than or equal to 1 μm and less than or equal to 1000 μm. When the electrolyte layer 202 has a thickness of greater than or equal to 1 μm, the positive electrode 201 and the negative electrode 203 are unlikely to be short-circuited. When the electrolyte layer 202 has a thickness of less than or equal to 1000 μm, the battery 1000 can operate at a high output.

The negative electrode 203 contains a material that can occlude and release metal ions such as lithium ions. The material is, for example, the negative electrode active material 205.

Examples of the negative electrode active material 205 are a metal material, a carbon material, an oxide, a nitride, a tin compound, and a silicon compound. The metal material may be a single metal or an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material 205 are silicon (i.e., Si), tin (i.e., Sn), a silicon compound, and a tin compound.

The shape of the negative electrode active material 205 is not particularly limited. The negative electrode active material 205 may be a particle. The negative electrode active material 205 may have a median diameter of greater than or equal to 0.1 μm and less than or equal to 100 μm. When the negative electrode active material 205 has a median diameter of greater than or equal to 0.1 μm, the negative electrode active material 205 and the solid electrolyte 100 can be well dispersed in the negative electrode 203. Consequently, the charge and discharge characteristics of the battery 1000 are improved. When the negative electrode active material 205 has a median diameter of less than or equal to 100 μm, the lithium diffusion speed in the negative electrode active material 205 is improved. Consequently, the battery 1000 can operate at a high output.

The negative electrode active material 205 may have a median diameter greater than that of the solid electrolyte 100. Consequently, the negative electrode active material 205 and the solid electrolyte 100 can be well dispersed.

In order to increase the energy density and output of the battery 1000, in the negative electrode 203, the ratio of the volume of the negative electrode active material 205 to the sum of the volume of the negative electrode active material 205 and the volume of the solid electrolyte 100 may be greater than or equal to 0.30 and less than or equal to 0.95.

In order to increase the energy density and output of the battery 1000, the negative electrode 203 may have a thickness of greater than or equal to 10 μm and less than or equal to 500 μm.

At least one selected from the group consisting of the positive electrode 201, the electrolyte layer 202, and the negative electrode 203 may contain the second solid electrolyte material for the purpose of enhancing the ion conductivity, chemical stability, and electrochemical stability.

The second solid electrolyte material may be a halide solid electrolyte.

Examples of the halide solid electrolyte are Li₂MgX′₄, Li₂FeX′₄, Li(Al,Ga,In)X′₄, and Li₃(Al,Ga,In)X′₆. Here, X′ is at least one selected from the group consisting of F, Cl, Br, and I.

Other examples of the halide solid electrolyte are compounds represented by LiₚMe_{q}YᵣZ′₆. Here, p+m′q+3r=6 and r>0 are satisfied. Me is at least one element selected from the group consisting of metal elements other than Li and Y and metalloid elements. The value of m′ represents the valence of Me. The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded). Z′ is at least one selected from the group consisting of F, Cl, Br, and I. From the viewpoint of the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The second solid electrolyte material may be a sulfide solid electrolyte.

Examples of the sulfide solid electrolyte are Li₂S—P₂₅₅, Li₂S—SiS₂, Li₂S—B₂S₃, Li₂S—GeS₂, Li_{3.25}Ge_{0.25}P_{0.75}S₄, and Li₁₀GeP₂S₁₂.

The second solid electrolyte material may be an oxide solid electrolyte.

Examples of the oxide solid electrolyte are:
(i) an NASICON-type solid electrolyte, such as LiTi₂(PO₄)₃ or its element substitute;
(ii) a perovskite-type solid electrolyte, such as (LaLi)TiO₃;
(iii) an LISICON-type solid electrolyte, such as Li₁₄ZnGe₄O₁₆, Li₄SiO₄, LiGeO₄, or its element substitute;
(iv) a garnet-type solid electrolyte, such as Li₇La₃Zr₂O₁₂ or its element substitute; and
(v) Li₃PO₄ or its N-substitute.

The second solid electrolyte material may be an organic polymeric solid electrolyte.

Examples of the organic polymeric solid electrolyte are a polymeric compound and a compound of a lithium salt. The polymeric compound may have an ethylene oxide structure. A polymeric compound having an ethylene oxide structure can contain a large amount of a lithium salt and can therefore further enhance the ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte solution, a gel electrolyte, or an ionic liquid for the purpose of facilitating the transfer of lithium ions and improving the output characteristics of the battery.

The nonaqueous electrolyte solution includes a nonaqueous solvent and a lithium salt dissolved in the nonaqueous solvent.

Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, greater than or equal to 0.5 mol/L and less than or equal to 2 mol/L.

As the gel electrolyte, a polymer material impregnated with a nonaqueous electrolyte solution can be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium and tetraalkylphosphonium;
(ii) aliphatic cyclic ammonium, such as pyrrolidiniums, morpholiniums, imidazoliniums, tetrahydropyrimidiniums, piperaziniums, and piperidiniums; and
(iii) a nitrogen-containing heterocyclic aromatic cation, such as pyridiniums and imidazoliums.

Examples of the anion included in the ionic liquid are PF₆, BF₄, SbF₆, AsF₆, SO₃CF₃, N(SO₂CF₃)₂, N(SO₂C₂F₅)₂, N(SO₂CF₃)(SO₂C₄F₉), and C(SO₂CF₃)₃.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyimide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer can also be used as the binder. Examples of such a binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the materials above may be used as the binder.

At least one selected from the group consisting of the positive electrode 201 and the negative electrode 203 may contain a conductive assistant for the purpose of enhancing the electron conductivity.

Examples of the conductive assistant are:
(i) graphite, such as natural graphite and artificial graphite;
(ii) carbon black, such as acetylene black and Ketjen black;
(iii) conductive fibers, such as carbon fibers and metal fibers;
(iv) carbon fluoride;
(v) metal powders, such as aluminum;
(vi) conductive whiskers, such as zinc oxide and potassium titanate;
(vii) a conductive metal oxide, such as titanium oxide; and
(viii) a conductive polymeric compound, such as polyaniline, polypyrrole, and polythiophene. In order to reduce the cost, the conductive assistant of the above (i) or (ii) may be used.

Examples of the shape of the battery according to the second embodiment are coin type, cylindrical type, square type, sheet type, button type, flat type, and stacked type.

The battery according to the second embodiment may be manufactured by, for example, providing a material for forming a positive electrode, a material for forming an electrolyte layer, and a material for forming a negative electrode and producing a stack in which a positive electrode, an electrolyte layer, and a negative electrode are disposed in this order by a known method.

### EXAMPLES

The present disclosure will now be described in more detail with reference to Examples.

### Example 1

Production of Li₂Te

Li and Te were provided as raw material powders at a molar ratio of Li:Te=2.5:1 in an argon atmosphere having a dew point of less than or equal to −60° C. (hereinafter, referred to as “dry argon atmosphere”). These raw material powders were pulverized and mixed in a mortar. Thus, a powder mixture was obtained. The powder mixture was heat-treated in a dry argon atmosphere at 500° C. for 1 hour. The resulting powder was pulverized in a mortar to obtain a power of Li₂Te.

### Production of Solid Electrolyte Material

Li₃N (manufactured by Sigma-Aldrich Co. LLC), Li₂Te, and ZnTe were provided as raw material powders at a molar ratio of Li₃N:Li₂Te:ZnTe=4:1:1 in the dry argon atmosphere. These raw material powders were pulverized and mixed in a mortar. Thus, a powder mixture was obtained. The powder mixture was subjected to milling treatment with a planetary ball mill at 500 rpm for 12 hours. Thus, a powder of the solid electrolyte material of Example 1 was obtained. The solid electrolyte material of Example 1 had a composition represented by Li₁₄ZnN₄Te₂.

The contents of Li, Zn, N, and Te per unit weight of the solid electrolyte material of Example 1 were measured by an XPS method. The Li:Zn:N:Te molar ratio was calculated based on the contents of Li, Zn, N, and Te obtained from the measurement results. As the results, the solid electrolyte material of Example 1 had a molar ratio of Li:Zn:N:Te=14:1:4:2 as in the molar ratio of the raw material powders.

### Experimental Evaluation of Ion Conductivity

FIG. 2 is a schematic view showing a compression molding dies 300 that is used for evaluating the ion conductivity of a solid electrolyte material.

The compression molding dies 300 included a punch upper part 301, a die 302, and a punch lower part 303. The punch upper part 301 and the punch lower part 303 were both formed from electron-conductive stainless steel. The die 302 was formed from insulating polycarbonate.

The ion conductivity of the solid electrolyte material of Example 1 was measured using the compression molding dies 300 shown in FIG. 2 by the following method.

The powder of the solid electrolyte material of Example 1 (i.e., the powder 101 of the solid electrolyte material in FIG. 2) was loaded inside the compression molding dies 300 in a dry atmosphere having a dew point of less than or equal to −30° C. A pressure of 300 MPa was applied to the solid electrolyte material of Example 1 inside the compression molding dies 300 using the punch upper part 301 and the punch lower part 303.

The punch upper part 301 and the punch lower part 303 were connected to a potentiostat (Princeton Applied Research, VersaSTAT4) equipped with a frequency response analyzer under application of the pressure. The punch upper part 301 was connected to the working electrode and the potential measurement terminal. The punch lower part 303 was connected to the counter electrode and the reference electrode. The impedance of a solid electrolyte material was measured by an electrochemical impedance measurement method at room temperature.

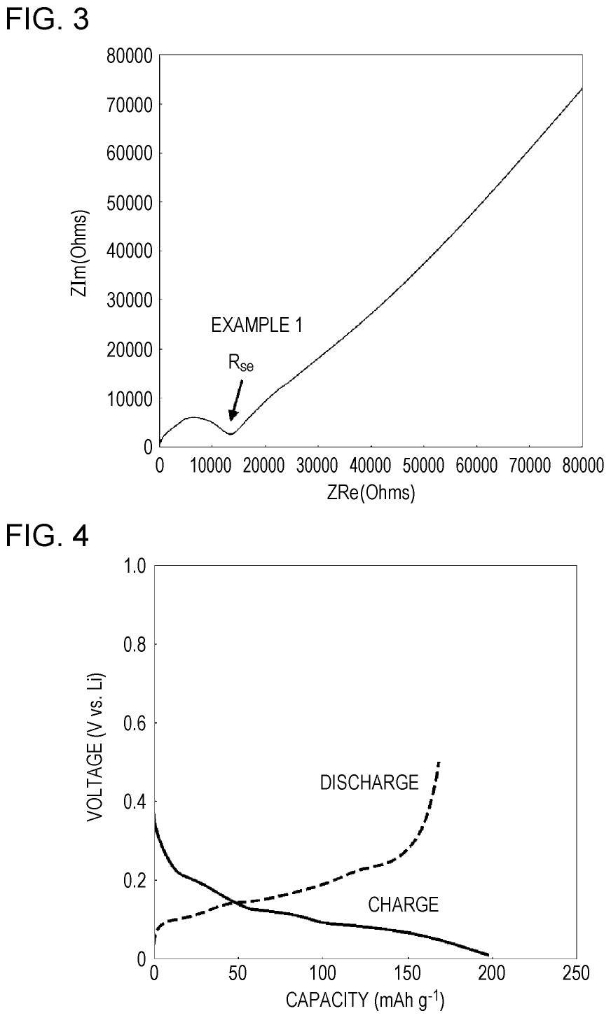

FIG. 3 is a graph showing a cole-cole plot obtained by impedance measurement of the solid electrolyte material of Example 1.

In FIG. 3, the real value of impedance at the measurement point where the absolute value of the phase of complex impedance was the smallest was regarded as the resistance value to the ionic conduction of the solid electrolyte material. Regarding the real value, see the arrow Rₛₑ shown in FIG. 3. The ion conductivity was calculated using the resistance value based on the following mathematical expression (2):

σ=(Rₛₑ×S/t)⁻¹ (2)

Here, σ represents ion conductivity; S represents the contact area of a solid electrolyte material with the punch upper part 301 (equal to the cross-sectional area of the hollow part of the die 302 in FIG. 2); Rₛₑ represents the resistance value of the solid electrolyte material in impedance measurement; and t represents the thickness of the solid electrolyte material (i.e., the thickness of the layer formed from the powder 101 of the solid electrolyte material in FIG. 2).

The ion conductivity of the solid electrolyte material of Example 1 measured at 25° C. was 8.61×10⁻⁶ S/cm.

### Production of Battery

The solid electrolyte material of Example 1 and graphite were provided at a volume ratio of 1:1 in a dry argon atmosphere. These materials were mixed in a mortar. Thus, a mixture was obtained.

An argyrodite-type sulfide solid electrolyte Li₆PS₅Cl (100 mg), the solid electrolyte material (30 mg) of Example 1, and the above mixture were stacked in this order in an insulating tube having an inner diameter of 9.5 mm. The amount of the mixture used contained 4 mg of graphite. A pressure of 740 MPa was applied to this stack to form a solid electrolyte layer and a first electrode.

Subsequently, metal In foil, metal Li foil, and metal In foil were stacked in this order on the solid electrolyte layer. A pressure of 40 MPa was applied to this stack to form a second electrode.

Subsequently, a current collector formed from stainless steel was attached to the first electrode and the second electrode, and a current collecting lead was attached to the current collector.

Finally, the inside of the insulating tube was isolated from the outside atmosphere using an insulating ferrule to seal the inside of the tube. Thus, a battery of Example 1 was obtained.

### Charge and Discharge Test

FIG. 4 is a graph showing the initial charge and discharge characteristics of a battery of Example 1. The initial charge and discharge characteristics were measured by the following method. The battery produced in Example 1 is a cell for a charge and discharge test and corresponds to a negative electrode half-cell. Accordingly, in Example 1, the direction in which the potential of a half-cell decreases by inserting lithium ions into the negative electrode is referred to as charge, and the direction in which the potential increases is referred to as discharge. That is, the charging in Example 1 is substantially (i.e., in a full-cell) discharge, and the discharging in Example 1 is substantially charge.

The battery of Example 1 was placed in a thermostat of 25° C.

The battery of Example 1 was charged at a current density of 14.9 μA/cm 2 until the voltage reached 0.0 V. The current density corresponds to a 0.01-C rate.

Subsequently, the battery of Example 1 was discharged at a current density of 14.9 μA/cm² until the voltage reached 0.5 V.

As the result of the charge and discharge test, the battery of Example 1 had an initial discharge capacity of 168 mAh.

### Computational Evaluation of Synthesizability

The synthesizability was evaluated by generating a model of Li₁₄ZnN₄Te₂ having a MgCu₂-type composite tetrahedral structure and calculating the convex hull energy by first-principle calculation.

In a model in which the Mg atom and the Cu atom of MgCu₂ crystal structure were substituted with a Te atom and a N atom, respectively, Li atoms and Zn atoms were randomly distributed in the center of a tetrahedron consisting of Te atoms and N atoms such that the molar ratio of Li:Zn:N:Te was 14:1:4:2. A hundred random distribution models were thus generated, structural relaxation was performed by first-principle calculation, the total energy was calculated, and a model with the minimum energy was obtained as MgCu₂-type Li₁₄ZnN₄Te₂. In the first-principle calculation, the VASP code was used.

Subsequently, the convex hull energy of the MgCu₂-type Li₁₄ZnN₄Te₂ model was calculated by first-principle calculation. The convex hull energy becomes an indicator of relative stability of a target phase with respect to another phase. In Li₁₄ZnN₄Te₂, since Li₈N₂Te, Li₂Te, and LiZnN coexist thermodynamically, the convex hull energy was calculated by the following expression (3):

Eₕᵤₗₗ(Li₁₄ZnN₄Te₂)=Eₜₒₜ(Li₁₄ZnN₄Te₂)−1.5Eₜₒₜ(Li₈N₂Te)−0.5Eₜₒₜ(Li₂Te)−Eₜₒₜ(LiZnN) (3).

Here, Eₕᵤₗₗ(A) represents the convex hull energy of A. Eₜₒₜ(A) represents the total energy of A. When the value is smaller than zero, the convex hull energy becomes zero. A convex hull energy closer to zero suggests thermodynamic stability.

### Computational Evaluation of Ion Conductivity

Using the MgCu₂-type Li₁₄ZnN₄Te₂ model obtained by the above method, the ion conductivity was evaluated by first-principle molecular dynamics calculation. The canonical ensemble was subjected to 35000 step calculations with each step 2 fs based on Nose algorithm at temperatures of 600K, 700K, and 800K. The obtained diffusion coefficient was extrapolated linearly to the reciprocal of temperature, and the ion conductivity a was calculated from the diffusion coefficient D at room temperature by the following expression (4):

σ=(ze)²nD/kT (4)

here, ze represents the electric charge; n represents the lithium ion density; k represents the Boltzmann's constant: and T represents the temperature.

### Experimental Analysis of Crystal Structure

In order to identify the crystal structure of the solid electrolyte material of Example 1, X-ray diffraction (XRD) measurement was performed. The measurement was performed using Cu-Kα rays as the X-rays in a dry argon atmosphere.

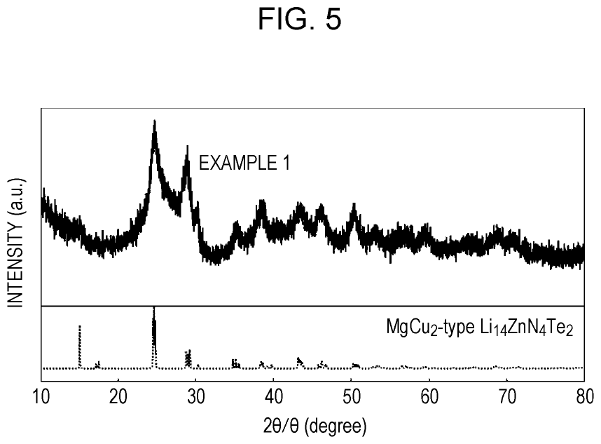

FIG. 5 is a graph showing an X-ray diffraction pattern of a solid electrolyte material of Example 1. The horizontal axis represents 20, and the vertical axis represents the X-ray diffraction intensity. The dotted line shows an X-ray diffraction pattern (i.e., simulation peak) of MgCu₂-type Li₁₄ZnN₄Te₂ predicted by calculation. The X-ray diffraction pattern of the solid electrolyte material of Example 1 agreed with the simulation peak of MgCu₂-type Li₁₄ZnN₄Te₂, and it was suggested that the anion framework has a MgCu₂-type structure.

### Examples 2 to 8

Structural models of Li₅P(Se₂Br)₂, Li₅P(Se₂I)₂, Li₆Si(S₂Cl)₂, Li₆Si(Se₂I)₂, Li₁₂Sn(SeN₂)₂, Li₁₀Sn(N₂Cl)₂, and Li₆Ge(Se₂I)₂ having MgCu₂-type anion framework were generated as those of Examples 2 to 8.

A hundred types of structural models were generated by substituting the base MgCu₂ with anions and placing Li atoms and cations at the tetrahedron sites, and the most stable structure was extracted by first-principle calculation.

In the obtained models, the convex hull energies and the ion conductivities were calculated as in Example 1. The results are shown in Table 1.

### Comparative Example 1

A structural model of Li₅PS₄Cl₂ disclosed in Non Patent Literature was generated as that of Comparative Example 1. Specifically, Ag atoms of base Ag₅P(S₂Cl)₂ were substituted with Li atoms. Regarding the obtained model, the convex hull energy and the ion conductivity were calculated as in Example 1. The results are shown in Table 1.

TABLE 1

| | | | Ion | Ion | |
|---|---|---|---|---|---|
| | | | conductivity | conductivity | Convex |
| | | | (experimental | (calculated | hull |
| | | Framework | value) | value) | energy |
| | Composition | type | (S/cm) | (S/cm) | (eV/atom) |
| Comparative | Li₅P(S₂Cl)₂ | NaHg₂ | — | 1.9 × 10⁻³ | 0.019 |
| Example 1 | | | | | |
| Example 1 | Li₁₄Zn(N₂Te)₂ | MgCu₂ | 8.61 × 10⁻⁶ | 7.9 × 10⁻³ | 0.003 |
| Example 2 | Li₅P(Se₂Br)₂ | MgCu₂ | — | 1.5 × 10⁻¹ | 0.000 |
| Example 3 | Li₅P(Se₂I)₂ | MgCu₂ | — | 5.2 × 10⁻² | 0.000 |
| Example 4 | Li₆Si(S₂Cl)₂ | MgCu₂ | — | 2.6 × 10⁻³ | 0.011 |
| Example 5 | Li₆Si(Se₂I)₂ | MgCu₂ | — | 1.9 × 10⁻² | 0.010 |
| Example 6 | Li₁₂Sn(N₂Se)₂ | MgCu₂ | — | 2.0 × 10⁻² | 0.009 |
| Example 7 | Li₁₀Sn(N₂Cl)₂ | MgCu₂ | — | 1.0 × 10⁻² | 0.000 |
| Example 8 | Li₆Ge(Se₂I)₂ | MgCu₂ | — | 2.8 × 10⁻² | 0.000 |

### CONSIDERATION

As obvious from Table 1, the solid electrolyte material of Example 1 is experimentally synthesized and has a high ion conductivity of greater than or equal to 7×10⁻⁶ S/cm at around room temperature. In addition, the solid electrolyte materials of Examples 2 to 8 have a calculated ion conductivity value of greater than or equal to 1×10⁻³ S/cm and can be expected to have a higher ion conductivity than that of Comparative Example. Accordingly, a solid electrolyte material including two or more types of cations and two or more types of anions, having an anion ratio (i.e., the molar ratio of the anion X to the anion Z) of less than or equal to 4, and having an anion framework with a MgCu₂-type structure has a high ion conductivity.

As also described in the paper by Wenhao, at al. (S. Wenhao, et al. “The thermodynamic scale of inorganic crystalline metastability” Science advances 2.11 (2016): e1600225), it is suggested that a solid electrolyte material can be synthesized as long as the convex hull energy is less than or equal to 0.1 eV. Accordingly, the solid electrolyte materials of Examples 2 to 8 can be synthesized.

In Example 1, the battery was charged and discharged at room temperature.

As described above, the solid electrolyte material of the present disclosure is a material that can improve lithium ion conductivity and is suitable for providing a battery that can be well charged and discharged.

The solid electrolyte material of the present disclosure is used in, for example, a battery (e.g., an all-solid-state lithium ion secondary battery).

What is claimed is:

1. A solid electrolyte material comprising:
a cation A that is an ion conductive species;
a cation B that is not an ion conductive species;
an anion X; and
an anion Z, wherein
the cation A is at least one element selected from the group consisting of alkali metal elements and alkaline earth metal elements,
the cation B is at least one element selected from the group consisting of alkali metal elements and alkaline earth metal elements other than the cation A, transition metal elements, the Group 13 elements, the Group 14 elements, the Group 15 elements, and the Group 16 elements,
the anion X and the anion Z are each independently at least one element selected from the group consisting of the Group 14 elements, the Group 15 elements, the Group 16 elements, and the Group 17 elements,
the anion X and the anion Z constitute an anion framework having a MgCu₂-type structure, and
a molar ratio of the anion X to the anion Z is greater than or equal to 1 and less than or equal to 4.

2. The solid electrolyte material according to claim 1, wherein
the cation A comprises lithium.

3. The solid electrolyte material according to claim 2, wherein
a molar ratio of the anion X to the anion Z is 2.

4. The solid electrolyte material according to claim 3, represented by a following formula (1):
Li_{4x+2z-b}BX₄Z₂ (1)
here,
B represents the cation B,
X represents the anion X,
Z represents the anion Z,
x represents an absolute value of valence of the anion X,
z represents an absolute value of valence of the anion Z, and
b represents an absolute value of valence of the cation B.

5. The solid electrolyte material according to claim 4, wherein
in the formula (1),
B is at least one selected from the group consisting of Zn, P, Si, Sn, and Ge.

6. The solid electrolyte material according to claim 4, wherein
in the formula (1),
B is Zn, and b is 2.

7. The solid electrolyte material according to claim 4, wherein
in the formula (1),
X is at least one element selected from the Group 15 elements, and x is 3; and
Z is at least one element selected from the Group 16 elements, and z is 2.

8. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer comprises the solid electrolyte material according to claim 1.
